(19) United States
(12) Patent Application Publication
(10) Pub. No.: US 2010/0207883 A1
(43) Pub. Date: Aug. 19, 2010

(54) MOUSE WITH MARKING FUNCTION

(75) Inventors: Qiang-Qiang Wang, Taipei (TW); Xin-Wu Lou, Taipei (TW)

Correspondence Address: KIRTON AND MCCONKIE, 60 EAST SOUTH TEMPLE,, SUITE 1800, SALT LAKE CITY, UT, 84111, US

(73) Assignee: Primax Electronics Ltd., Taipei (TW)

(21) Appl. No.: 12/414,477

(22) Filed: Mar. 30, 2009

(30) Foreign Application Priority Data
Feb. 13, 2009 (TW) 098104586

(51) Int. Cl. G09G 5/08

(52) U.S. Cl. 345/163

(57) ABSTRACT

A mouse having a marking function is provided. The mouse includes a first button, a second button, and a marking function triggering button. A mouse driver including a marking program is installed in the computer host. When the marking function triggering button is depressed, the marking program is activated. In response to a first button signal and a second button signal generated from the first button and the second button, various marking functions of the marking program are implemented.

### FIELD OF THE INVENTION

The present invention relates to an input device, and more particularly to an input device capable of implementing a marking function.

### BACKGROUND OF THE INVENTION

With rapid development of electronic and information industries, computers and the peripheral device thereof become essential parts in our daily lives. A typical computer system includes a computer host, an input device and a display device. The input device and the screen are connected with the computer host. The computer host can execute various application programs. Via a computer interface, images generated from the computer host can be displayed on a screen of the display device. The input device plays an important role in establishing contact between the computer host and the users. The common input device includes for example a mouse, a keyboards or a trackball.

In the early stage, a blackboard, a whiteboard or a slide projector is used to make a presentation, hold a meeting or give a lecture in a classroom, a boardroom, or a conference. The blackboard or the whiteboard can be used for writing notes. Nowadays, person computers gradually replace the blackboard, the whiteboard or the slide projector to make a presentation in a meeting. By installing a presentation program (e.g. Microsoft PowerPoint) in a personal computer, the lecturer or the presenter may operate a mouse to control playback of a slide file, thereby making a PowerPoint presentation in the form of a slide show. Moreover, the presentation program PowerPoint also has a writing function similar to the blackboard or the whiteboard.

When the computer is in the presentation mode, a right-click action of the mouse creates a presentation function menu (not shown) on the screen M. In a case that the user selects a pointer/pen function item from the presentation function menu, the pen drawing function is enabled for writing a text or a sign on the screen. By continuously depressing the left button of the mouse and moving the cursor C, one or more mouse writing signs W (e.g. a writing character “Green”, “Red”, and the like) are created on the screen M (see FIG. 1). In other words, the user may make notes or marking some portions of the image required for paying attention during the process of making the PowerPoint presentation.

The presentation program PowerPoint has a marking or writing function, which is executed only in the presentation mode. Generally, the user may paste the contents of some documents into the PowerPoint file and then implement associated marking functions. As known, some types of document files fail to be pasted into the PowerPoint file. For example, the design charts drawn by some graphics painting programs or the proceedings of executing the graphics painting programs fail to be displayed during the process of making the PowerPoint presentation. Under this circumstance, the presenter can only demonstrate the design charts or the proceedings of executing the graphics painting programs by oral explanation, which is not user-friendly. Moreover, since no marking function is usable in this circumstance, the audiences fail to well understand the contents of the presentation. Therefore, there is a need of providing a mouse capable of implementing the marking function on various document files and programs.

### SUMMARY OF THE INVENTION

It is an object of the present invention to provide a mouse having a marking function.

In accordance with an aspect of the present invention, there is provided a mouse having a marking function. The mouse generates a cursor moving signal to control a cursor on a screen that is connected to a computer host. The mouse includes a first button and a marking function triggering button. The first button is used for generating a first button signal. The marking function triggering button is used for generating a marking function triggering button. The marking function triggering button includes a mouse identification code and an activating signal. A mouse driver including a marking program is installed in the computer host. When the marking function triggering button is received by the mouse driver, the marking program is activated to implement the following steps. Firstly, a presentation image is created. In response to the first button signal and the cursor moving signal, a marking function or a mouse writing function is performed.

In an embodiment, the first button is a left button of the mouse.

In an embodiment, the mouse further includes a second button for generating a second button signal.

In an embodiment, the second button is a right button of the mouse.

In an embodiment, a marking option menu with multiple function items is created on the presentation image when the second button signal is received by the marking program. The marking function or the mouse writing function is enabled by selecting a marking function item or a mouse writing function item from the marking option menu.

In an embodiment, the function items of the marking option menu are selected to enable a straight line generating function, a pen size adjusting function, a pen/line color picking function, a transparence adjusting function, a marker color picking function, a text input function, a text font adjusting function, an eraser function, a file saving function, a new file saving function and an exit function, respectively.

In an embodiment, a thickness of a line that is generated by the mouse writing function is changeable when the pen size adjusting function is enabled.

In an embodiment, a line and a straight line that are generated by the mouse writing function and the straight line generating function are changeable when the pen/line color picking function is enabled.

In an embodiment, a transparence value of a marker that is generated by the marking function is changeable when the transparence adjusting function is enabled.

In an embodiment, a color of a marker that is generated by the marking function is changeable when the marker color picking function is enabled.

In an embodiment, when the text input function is enabled, a text or a symbol is inputted at a position of the presentation image where a click action of the first button is done.

In an embodiment, a font, font type, size or color of the text that is generated by the text input function is changeable when the text font adjusting function is enabled.

In an embodiment, a marker, text or line that is generated by the marking function or the mouse writing function is erasable when the eraser function is enabled.

In an embodiment, the presentation image is saved as an image file when the file saving function or the new file saving function is enabled.

In an embodiment, the image file is a PNG image file, a JPEG image file, a BMP image file or a GIF image file.

In an embodiment, a disabling signal is generated to disable the marking program when the exit function is enabled.

In an embodiment, the mouse further includes a saving prompt function. A saving prompt dialog box is created on the presentation image in response to the disabling signal before the marking program is disabled. A user can decide whether the presentation image is saver or not via the saving prompt dialog box.

In an embodiment, after the marking program is activated, a disabling signal is generated to disable the marking program by depressing the marking function triggering button of the mouse.

In an embodiment, the mouse further includes a saving prompt function. A saving prompt dialog box is created on the presentation image in response to the disabling signal before the marking program is disabled. A user can decide whether the presentation image is saver or not via the saving prompt dialog box.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a pointer/pen function is implemented on a screen to make notes when a computer is in a PowerPoint presentation mode according to the prior art;

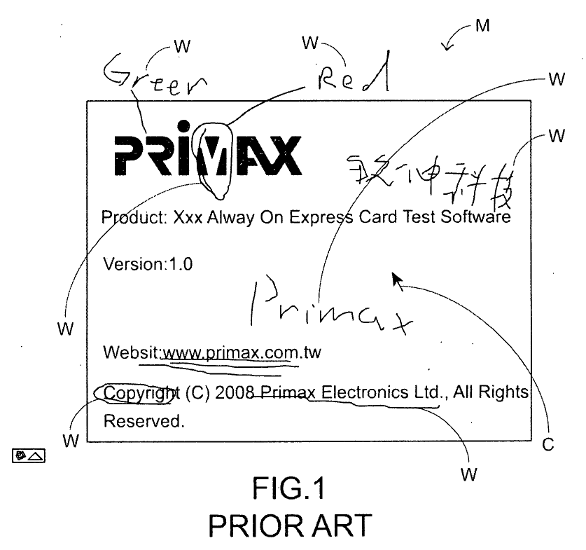

FIG. 2 is a schematic perspective view illustrating a computer system using the mouse of the present invention;

FIG. 3 is a schematic view illustrating the use of the mouse of the present invention to implement a straight line generating function, a mouse writing function, a marking function and a text input function on a presentation image of the screen;

FIG. 4 is a schematic view illustrating the use of the mouse of the present invention to create a marking option menu with multiple function items on the presentation image;

FIG. 5 is a schematic view illustrating the use of the mouse of the present invention to implement a transparence adjusting function so as to adjust the transparence of a marker on the presentation image;

FIG. 6 is a schematic view illustrating the use of the mouse of the present invention to implement a pen size adjusting function so as to adjust the font-weight of a mouse writing sign on the presentation image;

FIG. 7 is a schematic view illustrating the use of the mouse of the present invention to implement a pen/line color picking function on the presentation image;

FIG. 8 is a schematic view illustrating the use of the mouse of the present invention to implement a text font adjusting function on the presentation image;

FIG. 9 is a schematic view illustrating the use of the mouse of the present invention to implement a new file saving function on the presentation image; and

FIG. 10 is a schematic view illustrating the use of the mouse of the present invention to create a disabling confirmation dialog box on the presentation image.

### DETAILED DESCRIPTION OF THE PREFERRED EMBODIMENT

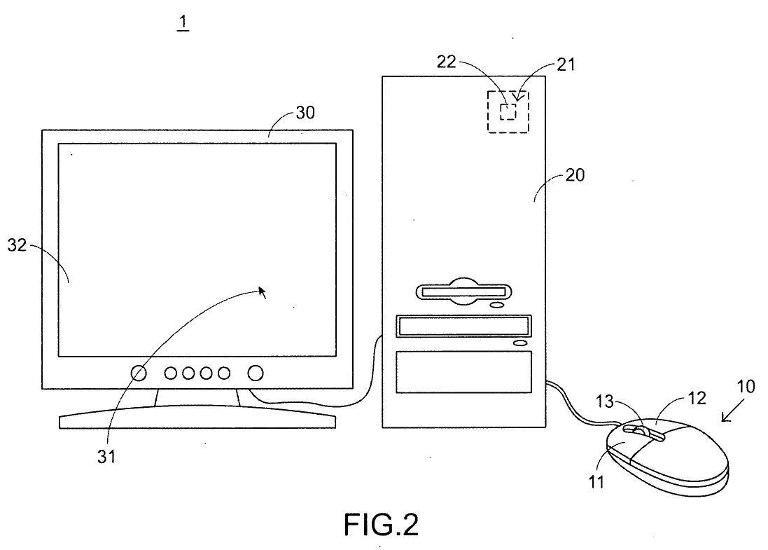

The present invention provides a mouse having a marking function. FIG. 2 is a schematic perspective view illustrating a computer system using the mouse of the present invention. As shown in FIG. 2, the computer system 1 principally comprises a mouse 10, a computer host 20 and a display device 30. The mouse 10 and the screen 30 are connected with the computer host 20. The computer host 20 can execute various application programs. Via a computer interface (e.g. a Microsoft Windows system), images generated from the computer host 20 can be displayed on a screen 32 of the display device 30. The mouse 10 can control movement of a cursor 31 that is shown on the screen 32. The mouse 10 includes a first button 11, a second button 12 and a marking function triggering button 13. When the first button 11 is depressed, a first button signal is generated. When the second button 12 is depressed, a second button signal is generated. When the marking function triggering button 13 is depressed, a marking function triggering signal is generated. The first button signal, the second button signal and the marking function triggering signal are transmitted to the computer host 20, thereby executing corresponding instructions. In this embodiment, the first button 11 and the second button 12 are the left button and the right button of the mouse 10, respectively.

A mouse driver 21 has been previously installed in the computer host 20 for driving specified functions of the mouse 10. The mouse driver 21 includes a marking program 22 for providing a marking function associated with the screen. When the marking function triggering signal transmitted from the mouse 10 is received by the computer host 20, the marking program 22 is activated. The marking function triggering signal includes a mouse identification code and an activating signal. The mouse identification code indicates the identity of the mouse 10. According to the mouse identification code, the computer host 20 can recognize whether the mouse 10 has been activated by the mouse driver 21. In response to the activating signal, the marking program 22 is activated. It is noted that, the marking program 22 is activated after the mouse identification code and the activating signal included in the marking function triggering signal are received by the computer host 20 and the identity of the mouse 10 is recognized. In other words, if the marking function triggering signal is not generated from the mouse 10 that is driven by the mouse driver 21 according to the mouse identification code included in the marking function triggering signal, the marking program 22 will not be activated by the computer host 20.

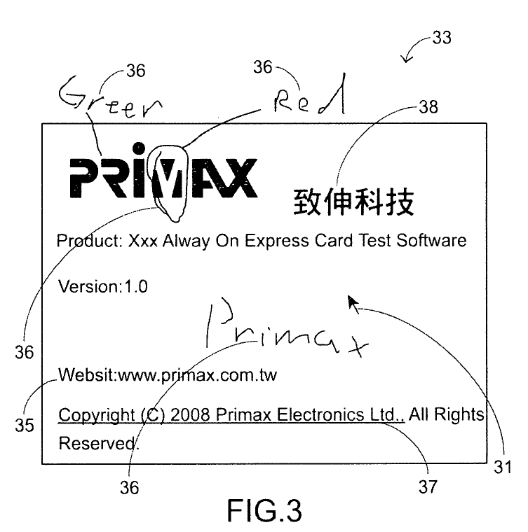

FIG. 3 is a schematic view illustrating the use of the mouse of the present invention to implement a straight line generating function, a mouse writing function, a marking function and a text input function on a presentation image of the screen. In an embodiment, the marking function is performed immediately after the marking program 22 is activated. For implementing the making function, an image file to be presented is opened and then displayed on the screen 32. After the image file is opened, the user may depress the marking function triggering button 13 of the mouse 10, so that a marking function triggering signal is transmitted from the mouse 10 to the computer host 20. In response to the marking function triggering signal, the computer host 20 will activate the marking program 22. In this embodiment, the marking function triggering button 13 is a scroll wheel of the mouse. When the scroll wheel is depressed, a wheel button function is enabled and thus the marking program 22 is activated.

After the marking program 22 is activated, a presentation image 33 is displayed on the screen 32. The presentation image 33 is substantially the same as the original image before the marking program 22 is activated. In other words, the presentation image 33 after the marking program 22 is activated is totally the same as the original image shown on the screen 32 before the marking program 22 is activated. Unlike the conventional pop-up window, the presentation image 33 will not jump out. For making notes on the presentation image 33, the user can locate the cursor 31 at a first position of the presentation image 33, then depresses the first button 11 (i.e. the left button) to generate a first button signal, and finally move the cursor 31 to generate a cursor moving signal. In response to the first button signal and the cursor moving signal, the marking program 22 will generate a marker 35 on the presentation image 33. An example of the marker 35 is a colored zone with transparence. The transparence of the colored zone is helpful to highlight some objects, texts or signs that are required for paying attention. Until the user stops depressing the left button 11, the generation of the marker 35 is ceased.

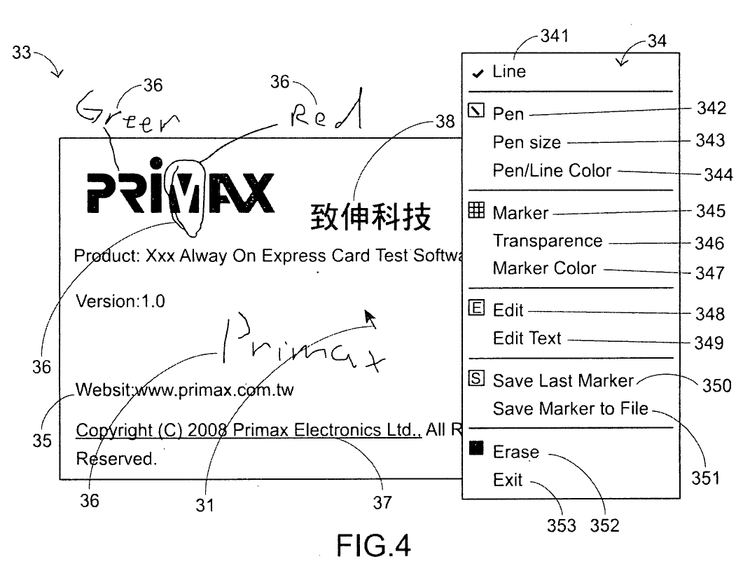

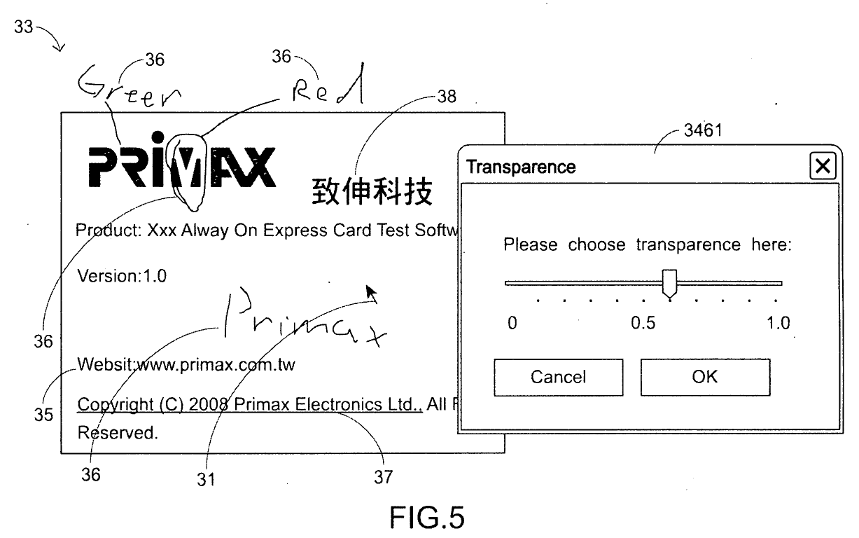

The transparence of the colored zone is adjustable. FIG. 4 is a schematic view illustrating the use of the mouse of the present invention to create a marking option menu with multiple function items on the presentation image. For executing other functions, the user may depress the second button 12 (i.e. the right button) of the mouse 10 to generate a second button signal. In response to the second button signal, the marking program 22 creates a marking option menu 34 on the presentation image 33. The transparence adjusting function item 346 is associated with the function of adjusting the transparence of the marker 35. When the user selects the transparence adjusting function item 346 from the marking option menu 34, a transparence adjusting dialog box 3461 is created (see FIG. 5). Via the transparence adjusting dialog box 3461, the user may choose desired transparence of the marker 35. As shown in FIG. 5, the transparence value of the marker 35 is ranged from 0 to 1. As the transparence value is closer to 1, the marker 35 is more transparent.

Please refer to FIG. 4. In addition to the marker item 345 and the transparence adjusting function item 346, the marking option menu 34 further includes a straight line generating function 341, a mouse writing function item 342, a pen size adjusting function item 343, a pen/line color picking function item 344, a marker color picking function item 347, a text input function item 348, a text font adjusting function item 349, a file saving function item 350, a new file saving function item 351 and an exit function item 353. For implementing other marking functions, the user can select desired function items from the marking option menu 34 according to the practical requirements. For example, when the user selects the mouse writing function item 342 from the marking option menu 34, the mouse writing function is enabled. By continuously depressing the left button 11 and moving the cursor 31 to generate a first button signal and a cursor moving signal, a mouse writing sign 36 is created on the presentation image 33 (see FIG. 3).

Furthermore, when the user selects the straight line generating function 341 from the marking option menu 34, the straight line generating function is enabled and thus a line 37 is displayed on the presentation image 33.

Furthermore, when the user selects the text input function item 348 from the marking option menu 34, the input text function is enabled. The user can locate the cursor 31 at a specified position of the presentation image 33, then depress the left button 11, and finally input a text 38 at the position where the left button 11 is depressed.

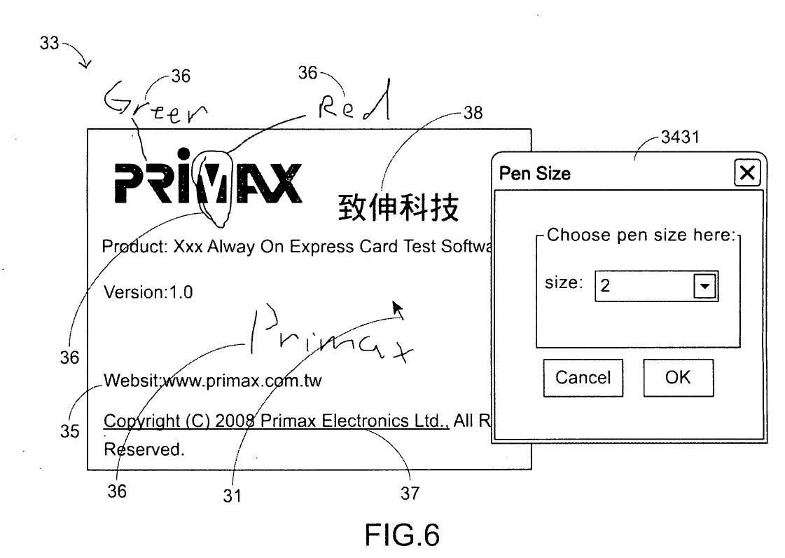

For changing the font-weight of the mouse writing sign 36, the user can select the pen size adjusting function item 343 from the marking option menu 34 such that a pen size adjusting dialog box 3431 is created on the presentation image 33. Via the pen size adjusting dialog box 3431, the user may choose desired pen size that is indicative of the line thickness (i.e. the font-weight of the mouse writing sign 36). As the pen size is increased, the font-weight of the mouse writing sign 36 is increased (see FIG. 6).

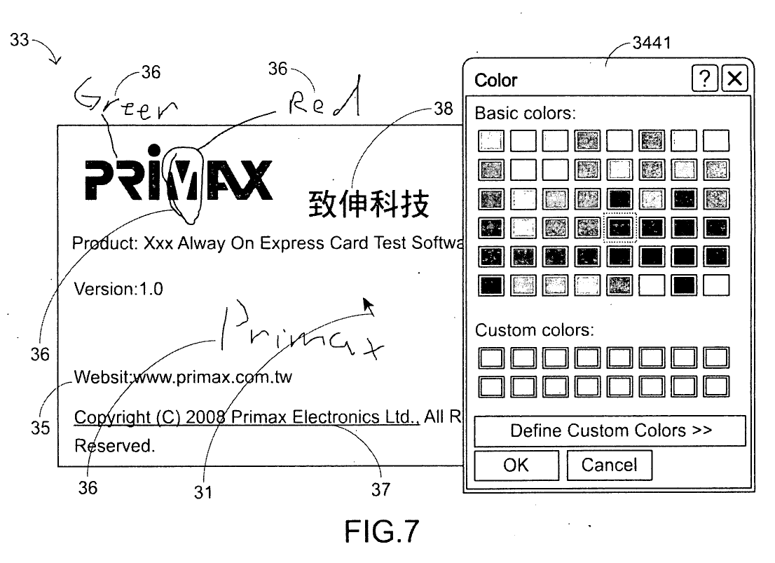

FIG. 7 is a schematic view illustrating the use of the mouse of the present invention to implement a pen/line color picking function on the presentation image. When the user selects the pen/line color picking function item 344 from the marking option menu 34 (as shown in FIG. 4), the pen/line color picking function is enabled. After the pen/line color picking function is enabled, a pen/line color change dialog box 3441 is created on the presentation image 33. By moving the cursor 31 to select desired colors from the pen/line color change dialog box 3441, the colors of the mouse writing sign 36 and the line 37 that are respectively generated by the mouse writing function and the straight line generating function are changeable.

Furthermore, when the user selects the marker color picking function item 347 from the marking option menu 34, the color of the marker 35 that is generated by the marking function is changeable. The operations of implementing the marker color picking function are similar to the operations of implementing the pen/line color picking function, and are not redundantly described herein.

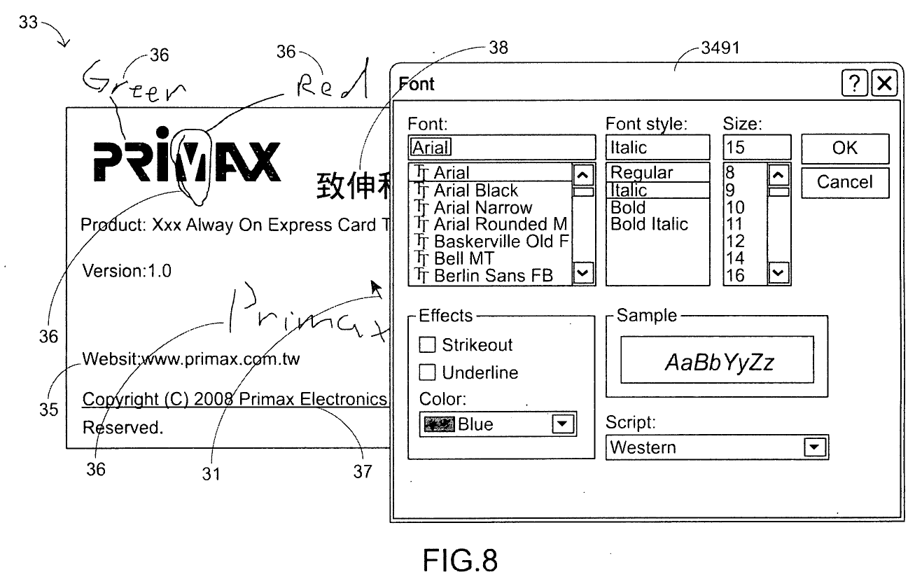

Please refer to FIG. 3 again. For changing the font, font type, size or color of the text 38, the user can select the text font adjusting function item 349 from the marking option menu 34 (as shown in FIG. 4) and thus a text font adjusting function is enabled. After the text font adjusting function is enabled, a text font adjusting dialog box 3491 is created on the presentation image 33. FIG. 8 is a schematic view illustrating the use of the mouse of the present invention to implement a text font adjusting function on the presentation image. Via the text font adjusting dialog box 3491, the user can choose a desired font, font type, size or color of the text 38.

From the above embodiments, the colors of the marker 35, the mouse writing sign 36, the line 37 and the text 38 are changeable for facilitating recognition. Moreover, the marking option menu 34 provided by the marking program 22 further includes an eraser function item 352. The user can select the eraser function item 352 from the marking option menu 34, thereby erasing the erroneous contents of the marker, mouse writing sign, line or text on the presentation image 33.

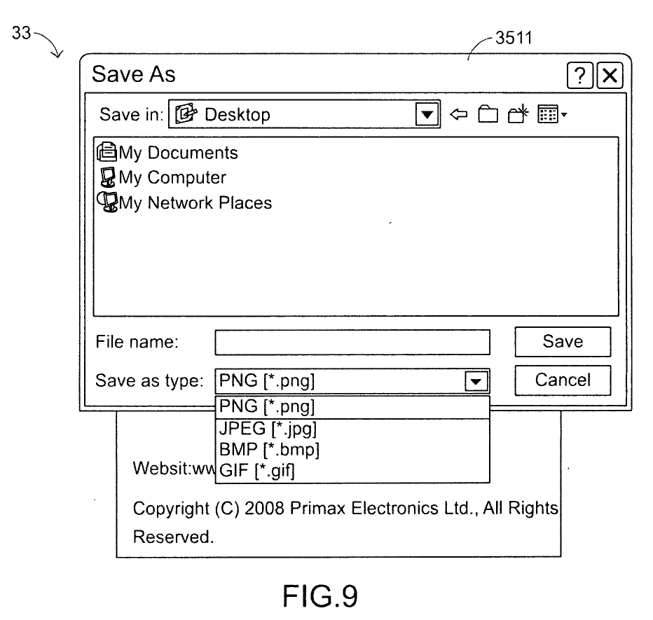

After the presentation image 33 has been marked or written, the user can select the file saving function item 350 from the marking option menu 34, thereby saving the presentation image 33 as an image file. FIG. 9 is a schematic view illustrating the use of the mouse of the present invention to implement a new file saving function on the presentation image. When the user selects the new file saving function item 351 from the marking option menu 34 (see FIG. 4), a new file saving dialog box 3511 is created on the presentation image 33. Via the new file saving dialog box 3511, the presentation image 33 can be saved as another image file in a different format or in a specified site of the computer host 20. Depending on the format, the image file is a PNG image file, a JPEG image file, a BMP image file or a GIF image file.

For disabling the marking program 22, the user can select the exit function item 353 from the marking option menu 34 (see FIG. 4) and thus a disabling signal is generated. In response to the disabling signal, the marking program 22 is disabled. Alternatively, when the marking program 22 is activated, the user may depress the marking function triggering button 13 of the mouse 10 again, so that a disabling signal is transmitted from the mouse 10 to the computer host 20 to disable the marking program 22. After the marking program 22 is disabled, the marked presentation image 33 is also closed. At this moment, the image shown on the screen 32 is the same as the original image (i.e. the unmarked presentation image 33) before the marking program 22 is activated.

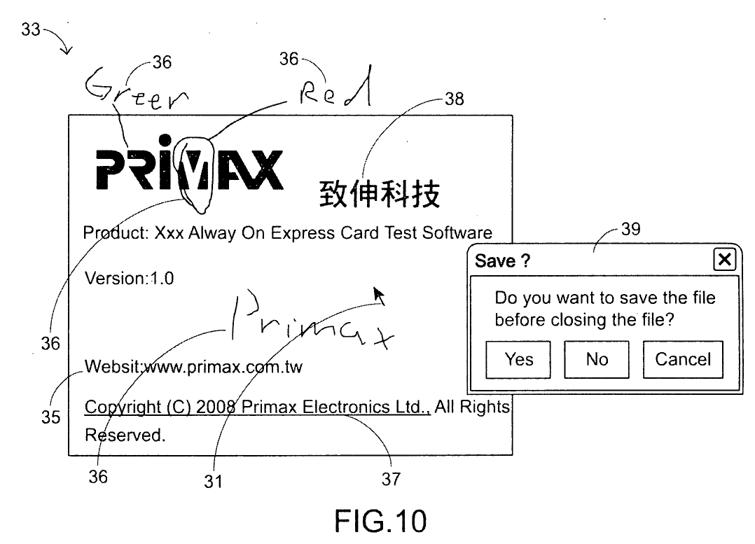

Moreover, for preventing from erroneously depressing the marking function triggering button 13 to disable the marking program 22, a saving prompt dialog box 39 is created on the presentation image 33 (see FIG. 10) when the disabling signal is depressed. Via the saving prompt dialog box 39, the user may decide whether the presentation image 33 is saved or not.

From the above description, the marking program installed in the computer host is activated when the marking function triggering button of the mouse of the present invention is depressed. By using the mouse to control the cursor, various marking tasks can be performed on the presentation image. Since the operations of the marking program are similar to the presentation program PowerPoint, the use of the mouse of the present invention to execute the marking program is very easy. In addition to the presentation program PowerPoint, the mouse of the present invention can be used to implement the marking function on the presentation image during execution of other program or software. That is, the mouse of the present invention can be used to implement the marking function on any image that is able to be shown on the computer screen. The marking function can be performed on the desktop of the computer or the images of two document files. Since the marking program is activated to execute associated tasks by depressing the marking function triggering button, the method of implementing the marking function by using the mouse of the present invention is simplified and time-saving. In addition, the mouse of the present invention can be used with any program or software capable of creating images on the computer screen.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse having a marking function, said mouse generating a cursor moving signal to control a cursor on a screen that is connected to a computer host, said mouse comprising:
a first button for generating a first button signal; and
a marking function triggering button for generating a marking function triggering signal, said marking function triggering signal including a mouse identification code and an activating signal,
wherein a mouse driver including a marking program is installed in said computer host, and when said marking function triggering button is received by said mouse driver, said marking program is activated to implement steps of: creating a presentation image, and performing a marking function or a mouse writing function in response to said first button signal and said cursor moving signal.

2. The mouse according to claim 1 wherein said first button is a left button of said mouse.

3. The mouse according to claim 1 further comprising a second button for generating a second button signal.

4. The mouse according to claim 3 wherein said second button is a right button of said mouse.

5. The mouse according to claim 3 wherein a marking option menu with multiple function items is created on said presentation image when said second button signal is received by said marking program, and said marking function or said mouse writing function is enabled by selecting a marking function item or a mouse writing function item from said marking option menu.

6. The mouse according to claim 5 wherein said function items of said marking option menu are selected to enable a straight line generating function, a pen size adjusting function, a pen/line color picking function, a transparence adjusting function, a marker color picking function, a text input function, a text font adjusting function, an eraser function, a file saving function, a new file saving function and an exit function, respectively.

7. The mouse according to claim 6 wherein a thickness of a line that is generated by said mouse writing function is changeable when said pen size adjusting function is enabled.

8. The mouse according to claim 6 wherein a line and a straight line that are generated by said mouse writing function and said straight line generating function are changeable when said pen/line color picking function is enabled.

9. The mouse according to claim 6 wherein a transparence value of a marker that is generated by said marking function is changeable when said transparence adjusting function is enabled.

10. The mouse according to claim 6 wherein a color of a marker that is generated by said marking function is changeable when said marker color picking function is enabled.

11. The mouse according to claim 6 wherein when said text input function is enabled, a text or a symbol is inputted at a position of said presentation image where a click action of said first button is done.

12. The mouse according to claim 11 wherein a font, font type, size or color of said text that is generated by said text input function is changeable when said text font adjusting function is enabled.

13. The mouse according to claim 6 wherein a marker, text or line that is generated by said marking function or said mouse writing function is erasable when said eraser function is enabled.

14. The mouse according to claim 6 wherein said presentation image is saved as an image file when said file saving function or said new file saving function is enabled.

15. The mouse according to claim 14 wherein said image file is a PNG image file, a JPEG image file, a BMP image file or a GIF image file.

16. The mouse according to claim 6 wherein a disabling signal is generated to disable said marking program when said exit function is enabled.

17. The mouse according to claim 16 wherein said mouse further includes a saving prompt function, a saving prompt dialog box is created on said presentation image in response to said disabling signal before said marking program is disabled, and a user decides whether said presentation image is saver or not via said saving prompt dialog box.

18. The mouse according to claim 1 wherein after said marking program is activated, a disabling signal is generated to disable said marking program by depressing said marking function triggering button of said mouse.

19. The mouse according to claim 18 wherein said mouse further includes a saving prompt function, a saving prompt dialog box is created on said presentation image in response to said disabling signal before said marking program is disabled, and a user decides whether said presentation image is saver or not via said saving prompt dialog box.
